(19) United States
(12) Patent Application Publication
(10) Pub. No.: US 2011/0295656 A1
(43) Pub. Date: Dec. 1, 2011

(54) SYSTEM AND METHOD FOR PROVIDING BALANCED SCORECARD BASED ON A BUSINESS INTELLIGENCE SERVER

(75) Inventors: Raghuram Venkatasubramanian, Cupertino, CA (US); Roger Bolsius, Round Rock, TX (US); Harvard Pan, Boston, MA (US); Alextair Mascarenhas, Foster City, CA (US); Saugata Chowdhury, Sunnyvale, CA (US); Venugopal Surendran, Santa Clara, CA (US); Ananth Venkata, San Ramon, CA (US); Jacques Vigeant, Fort Lauderdale, FL (US)

(73) Assignee: ORACLE INTERNATIONAL CORPORATION, Redwood Shores, CA (US)

(21) Appl. No.: 13/100,257

(22) Filed: May 3, 2011

Related U.S. Application Data
(60) Provisional application No. 61/349,714, filed on May 28, 2010.

(51) Int. Cl. G06Q 10/00

(52) U.S. Cl. 705/7.39

(57) ABSTRACT

A scorecard application can support business strategy management using a business intelligence (BI) server. The BI server can take inputs from different data sources. The scorecard application can define an internal data structure that holds a plurality of strategy components and one or more key performance indicators (KPIs). Then, the scorecard application can populate each said strategy component in the internal data structure based on the inputs from the different data sources, and perform one or more actions once an alert is triggered, wherein the alert is triggered when a said KPI meets one or more criteria.

### CLAIM OF PRIORITY

This application claims priority to the following application, which is hereby incorporated by reference in its entirety: U.S. Provisional Application No. 61/349,714, entitled “SYSTEM AND METHOD FOR PROVIDING BALANCED SCORECARD BASED ON A BUSINESS INTELLIGENCE SERVER”, filed on May 28, 2010.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The present invention generally relates to business strategy management, and particularly to supporting business strategy management using a business intelligence (BI) server.

### BACKGROUND

In the context of computer software, and particularly computer databases, the term “data warehouse” is generally used to refer to a unified data repository for all customer-centric data. A data warehouse environment tends to be quite large. The data stored in the data warehouse can be cleaned, transformed, and catalogued. Such data can be used by business professionals for performing business related operations, such as data mining, online analytical processing, and decision support. Typically, a data warehouse can be associated with extract, transform, and load (ETL) processes and business intelligence tools. The ETL processes are capable of extracting data from source systems and bringing the data into a data warehouse. The business intelligence tools are designed to report, analyze and present data stored in the data warehouse. This is the general area that embodiments of the invention are intended to address.

### SUMMARY

In accordance with an embodiment, a scorecard application can support business strategy management using a business intelligence (BI) server. The BI server can take inputs from different data sources. The scorecard application can define an internal data structure that holds a plurality of strategy components and one or more key performance indicators (KPIs). Then, the scorecard application can populate each said strategy component in the internal data structure based on the inputs from the different data sources, and perform one or more actions once an alert is triggered, wherein the alert is triggered when a said KPI meets one or more criteria.

### BRIEF DESCRIPTION OF THE FIGURES

FIG. 1 illustrates an exemplary view of a business strategy management environment in accordance with an embodiment.

FIG. 2 illustrates an exemplary flow chat for supporting business strategy management using the scoreboard application in accordance with an embodiment.

FIG. 3 illustrates an exemplary user interface for presenting the key performance indicators in accordance with an embodiment.

FIG. 4 illustrates an exemplary user interface for presenting a cause and effect map in accordance with an embodiment.

FIG. 5 illustrates an exemplary view of the balanced scorecard methodology in accordance with an embodiment.

FIG. 6 illustrates an exemplary user interface for a balanced scorecard in accordance with an embodiment.

FIG. 7 illustrates an exemplary strategy tree in a balanced scorecard in accordance with an embodiment.

FIG. 8 illustrates an exemplary user interface for presenting a strategy map in accordance with an embodiment.

FIG. 9 is an illustration that shows an example of a user-customized strategy map in accordance with an embodiment.

FIG. 10 illustrates an exemplary user interface for presenting an accountability map in accordance with an embodiment.

### DETAILED DESCRIPTION

The present invention is illustrated, by way of example and not by way of limitation, in the figures of the accompanying drawings in which like references indicate similar elements. It should be noted that references to “an” or “one” or “some” embodiment(s) in this disclosure are not necessarily to the same embodiment, and such references mean at least one. The description of the embodiments of the invention as following uses the balanced scorecard (BSC) methodology as an example for businesses to define/articulate strategies with different perspectives. It will be apparent to those skilled in the art that other types of business management methodologies can be used without limitation.

As described herein, a data warehouse can be used to store critical business information. Business intelligence (BI) applications running on top of the data warehouse can provide powerful tools to the users for managing and operating their business. These BI tools can not only help the users run their day-to-day business, but also help the users make critical tactical, or even long term strategic, business decisions.

There can be different types of BI applications used in the enterprise environment, such as sales, marketing, supply chain, financial, and human resource applications. An application framework, such as ADF, can be used to implement the different types of BI applications. Each BI application can store and use one or more application data objects in its own application data store, outside of the data warehouse.

A BI server can reside between the BI applications and the data warehouse. The BI server allows the BI applications to use high-level analytical queries to scan and analyze large volumes of data in the data warehouse using complex formulas, in order to provide efficient and easy access to information required for business decision making. The BI applications can rely on the BI server to fulfill its analytic requirement.

Strategic management systems enable organizations to articulate their business strategy and translate their strategy into actions. For example, a system, which provides information in the form of a scorecard application, may include an (1) articulated strategy, (2) descriptions of the activities required to implement the strategy, (3) infrastructure to monitor progress on the strategy implementation, and (4) workflow infrastructure for action corrective measures. Business strategy management applications based on the BI server can deliver contextual, relevant and actionable insight to everyone in an organization, resulting in improved decision-making, better-informed actions, and more efficient business processes.

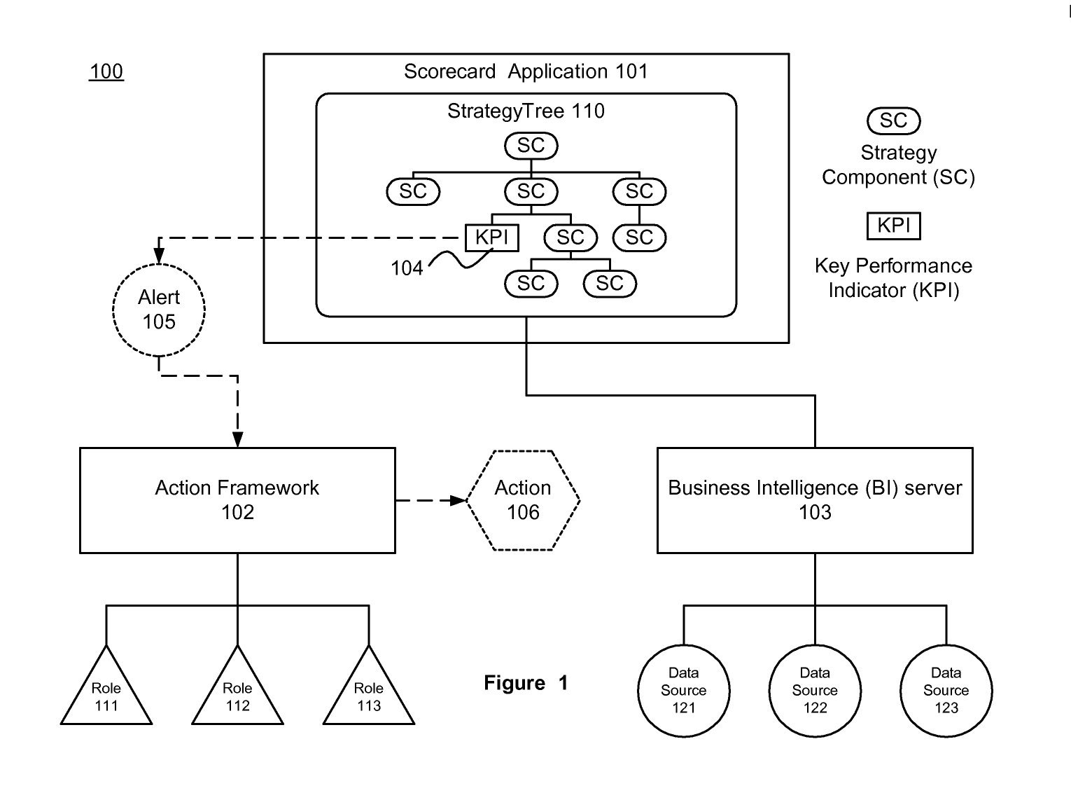

FIG. 1 illustrates an exemplary view of a business strategy management environment in accordance with an embodiment. As shown in FIG. 1, the business strategy management environment 100 includes a scorecard application 101 and a BI server 103. The BI server 103 can integrate information from different data sources 121, 122, and 123 and provide the integrated information to the scorecard application. There can be multiple data sources co-existing within an organization. The information provides by these data sources can be incompatible, or even inconsistent in some cases, because different segments within an organization can be responsible for maintaining its own version of the information.

The scorecard application can take the input information from different data sources and populate its internal data structures with different data component. In accordance with an embodiment, an internal data structures for the scorecard application is a strategy tree 110 that includes hierarchically defined components such as a plurality of strategy components and one or more key performance indicators (KPIs) 104.

Furthermore, the business strategy management environment can include an action framework 102. The action framework can generate different actions for the scorecard application, based on different roles 111, 112, and 113 associated with a user of the scorecard application. The scorecard application can cause one or more actions to be performed once an alert 105 that is associated with the strategy tree 110 is triggered. The alert can be trigged when a said KPI meets one or more criteria. In another embodiment, when the alert is triggered, the scorecard application can recommend to the user a particular action 106 to be performed based on a particular role associated with the user.

In accordance with an embodiment, a scorecard application can provide the capability of integrating information from different data sources. For example, a sales manager, who manages the sales of a product, can use the scorecard application to support his business strategy management. The sales manager can set up a sales target in a spreadsheet document, while collecting and maintaining the actual sales information in a database. Here, the database is a different data source from the spreadsheet document and requires separate handling. A BI server can be used to integrate the information from both the spreadsheet document and the database, and provide the combined information to the scorecard application. The scorecard application can then use the information such as the sales target from the spreadsheet document and the actual sales information from the database, to help the sale manager evaluating whether the sales target of the product has been met or not.

In accordance with an embodiment, the scorecard application allows users to associate strategy components with the metrics that are required to monitor the progress on attaining the strategic objectives. Metrics are quantifiable performance statements that are relevant to the strategy components. Additionally, the metrics can be placed in the context of a target to be reached in an identified time frame, and are capable of being trended and owned by a designated person or group who has the ability to impact those measures. In accordance with an embodiment, an organization can have a variety of types of measures. Some measures can be calculated from underlying data. Other measures can be aggregated index measures that assign different weights to multiple contributing measures. Some measures are frequently measured and others may only be measured on a quarterly or annual basis.

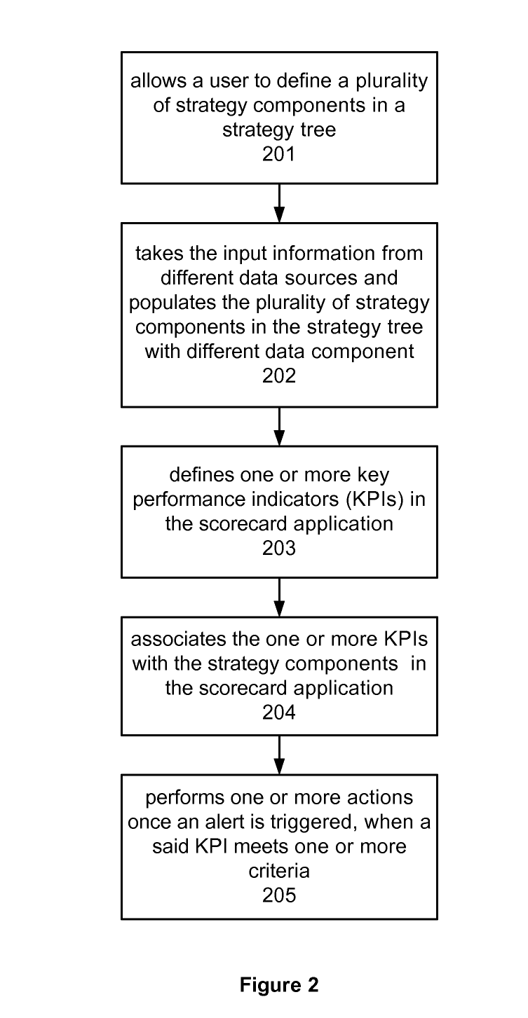

FIG. 2 illustrates an exemplary flow chat for supporting business strategy management using the scoreboard application in accordance with an embodiment. As shown in FIG. 2, the scorecard application allows a user to define a plurality of strategy components in a strategy tree 201. The scorecard application can then take the input information from different data sources and populate the plurality of strategy components in the strategy tree with different data component 202. Additionally, users can define one or more KPIs within operational dashboards in the scorecard application 203. Users can associate the one or more KPIs with the strategy components within the operational dashboards in the scorecard application, in order to monitor and/or react to their operational metrics 204. Then, the scorecard application can perform one or more actions once an alert is triggered, wherein the alert is triggered when a said KPI meets one or more criteria 205.

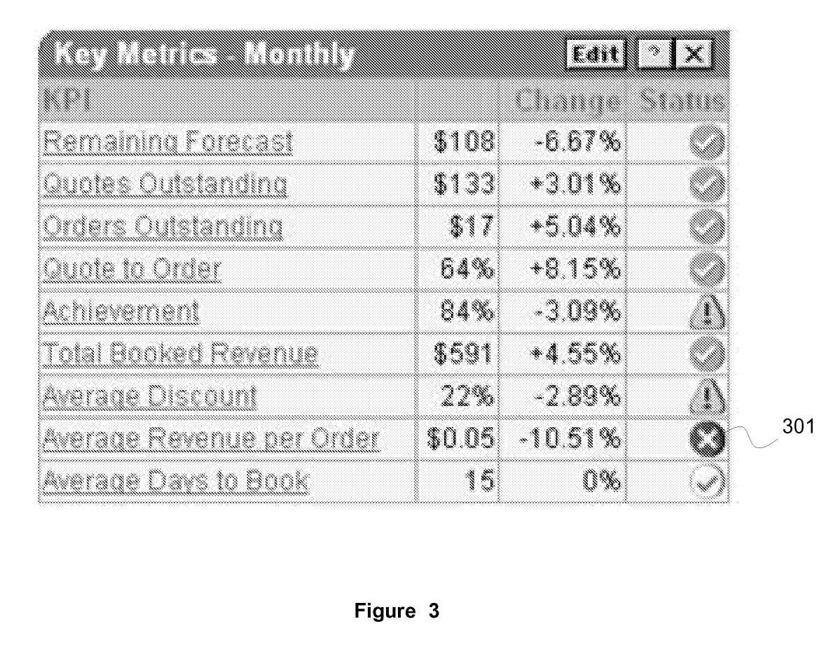

FIG. 3 illustrates an exemplary user interface (UI) for presenting the key performance indicators (KPIs) in accordance with an embodiment. As shown in FIG. 3, the exemplary user interface includes multiple KPIs. Each KPI shown in the exemplary user interface is associated with a value, a change and a status. The scorecard application can use one or more assessment rules to determine the KPI status at any given time. In the example as shown in FIG. 3, the “Average Revenue per Order” KPI 301 is in a critical range that requires for attention from the user of the scoreboard application.

### Strategy Components

The scorecard application can employ different strategy components to provide users with the concepts and means to articulate various business strategies. The scorecard application allows users to associate different strategy components with the task and activities that are required to achieve the strategic objectives. Furthermore, the scorecard application allows users to seamlessly navigate from the strategy component to the task and activities and also to the metrics. The following sections include exemplary strategy components.

### Perspective

In accordance with an embodiment, the system allows a user to define a perspective strategy component in the strategy tree. A perspective strategy component represents a stakeholder category or point of view. The scorecard application can describe strategy and performance management from multiple perspectives.

In accordance with an embodiment, the strategy for an enterprise can be decomposed into different perspectives to drive implementation. Each perspective can be explained by a key question with which the perspective is associated. The answers to each key question become the objectives associated with that perspective, and the performance is then judged by the progress to achieving these objectives. In an embodiment, there can be an explicit causal relationship between the perspectives: good performance in the “Learning and Growth” perspectives generally drives improvements in the “Internal Business Process” perspectives, which should improve the organization in the eyes of the customer, which ultimately leads to improved financial results.

Each of these perspectives can reflect a unique organizational strategy. Therefore, the perspectives and key questions can be amended and supplemented as necessary to capture that strategy. For example, a non-profit or government organization does not have the same perspectives as a corporation which is for-profit.

### Vision

In accordance with an embodiment, the system also allows a user to define a vision strategy component in the strategy tree. The vision strategy component defines a short, succinct, and inspiring statement of what the organization intends to become and to achieve at some point in the future. The statement often includes competitive sentences and terms. The vision strategy component often refers to the category of intentions that are broad and forward thinking.

### Mission

In accordance with an embodiment, the system also allows a user to define a mission strategy component in the strategy tree. The mission strategy component states an organization's vision which is translated into a written form. The mission strategy component makes concrete the leader's view of the direction and purpose of the organization. For many corporate leaders, the mission is a vital element in any attempt to motivate employees and to give them a sense of priorities. A mission statement can also be a short and concise statement of goals and priorities.

### Objective

In accordance with an embodiment, the system also allows a user to define an objective strategy component in the strategy tree. The objective strategy component defines desired outcomes. The progress toward attaining an objective strategy component can be described by one or more measures. Similar to the perspectives, there can be causal relationships between objectives. In an embodiment, the causal relationship is defined based on the dependencies among objectives. And, the causal relationship is critical to set measurable, strategically relevant, consistent, time-delineated objectives.

In accordance with an embodiment, objectives are related to one another through cause and effect relationships. The cause and effect linkages are similar to “if-then” statements. For example, if an airline decreases the on-ground turn-around time (objective 1), then the airline requires fewer planes (objective 2) and customers can be more satisfied with on-time take off (objective 3) and corporate profitability can increase (objective 4).

The cause and effect linkages can have certain properties such as Lag/Lead direction and strength or correlation coefficient. In some embodiments, these cause and effect linkages can be explicit and generated by the system automatically.

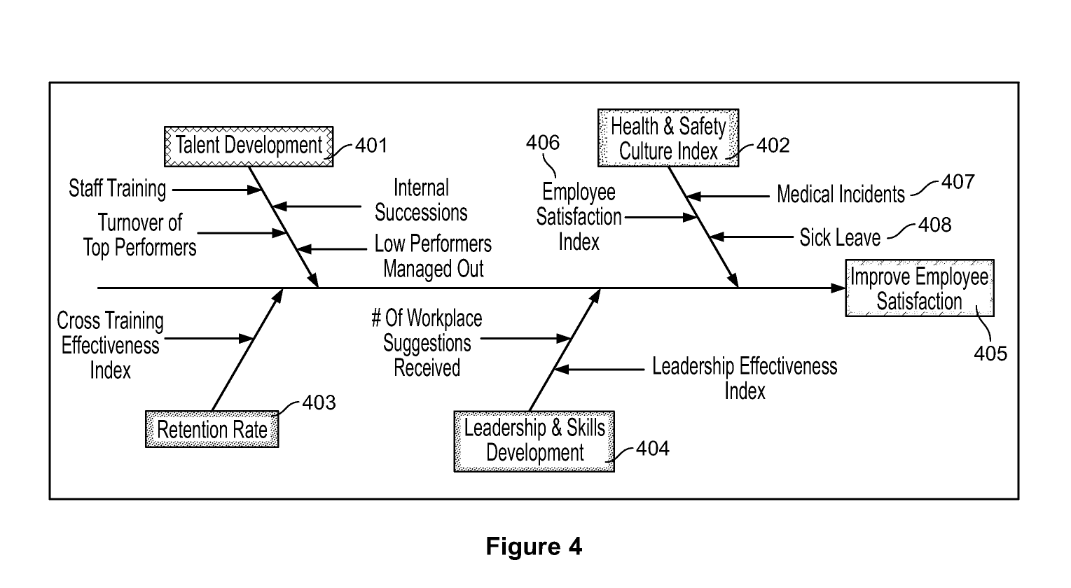

FIG. 4 illustrates an exemplary user interface (UI) for presenting a cause and effect map in accordance with an embodiment. FIG. 4 specifies different cause and effect linkages among the different strategy components and the objective of “Improve Employee Satisfaction 405,” using a fishbone style diagram. As shown in FIG. 4, different strategy components, such as “Talent Development 401,” “Health & Safety Culture Index 402,” “Retention Rate 403,” and “Leadership & Skills Development 404,” can contribute to an objective of “Improve Employee Satisfaction.”

The strategy component of “health & Safety Culture Index” can be highlighted to indicate that the best way to realize the objective of improving employee satisfaction is through improving the Health & Safety Culture Index, which is measured by different KPIs, such as “Employee Satisfaction Index 406,” “Medical Incidents 407,” and “Sick Leave 408.”

### Strategic Theme

In accordance with an embodiment, the system also allows a user to define a strategic theme strategy component in the strategy tree. The strategic theme strategy component includes descriptive statement representing a major component of a strategy, as articulated at the highest level in the vision. Themes represent vertically linked groupings of objectives across several scorecard perspectives.

### Strategic Thrust

In accordance with an embodiment, the system also allows a user to define a strategic thrust strategy component in the strategy tree. The strategic thrust strategy component defines the main goals that an organization is striving to achieve. In an exemplary strategy hierarchy, strategic thrusts are directly subordinate to vision. In some examples, strategic thrusts are not directly associated with KPIs.

### Critical Success Factor (CSF)

The system also allows a user to define a critical success factor (CSF) strategy component in the strategy tree. The CSF strategy component includes one or more key factors and objectives that must be accomplished for a particular strategic thrust. These are the specific tasks that an organization must do well or excel at to achieve its goals. In an exemplary strategy hierarchy, the CSFs are directly subordinate to strategic thrusts. Different KPIs can be attached to CSFs as long as there are no CSFs below the KPIs. In an embodiment, CSFs can be treated the same as an objective.

### Initiative

In accordance with an embodiment, the system also allows a user to define an initiative strategy component in the strategy tree. The initiative strategy component defines a change process or an activity designed process to achieve one or more objectives. The initiative strategy component is what can move a measure toward its target value. Initiatives can be large or small in scope. Initiatives generally are owned by a person or a group, and are managed like projects. Initiatives are generally tracked in external systems. For example, the initiatives can refer to a project, which is defined and tracked in a project management system.

### Assessment

In accordance with an embodiment, the system also allows a user to define an assessment strategy component in the strategy tree. The assessment strategy component includes assessment rules. The assessment rules allow the scorecard application to define the status of a strategy component at any point in time. The status, as evaluated, is called an assessment. In some examples, assessments can have associated visual indicators, such as green for good and red for needs attention, etc. In an embodiment, both strategy components and KPIs can have assessments.

### Effective Date

In accordance with an embodiment, the system also allows a user to define additional strategic component, such as effective date, allows a user to store historical data, see changes in organization data over time, and enter future data. For example, a user may want to track several events in the career of an employee, such as when the employee was hired, transferred, and promoted. By inserting rows of data based on the employee ID, the user can build a job history.

When a user enters new information that is related to existing data, such as a transfer or pay rate change, the user doesn't want to lose or overwrite the data already stored in the database. To retain history, the user can add a data row identified by the effective date, which is the date when the information goes into effect. The user can use the information to check what has happened up to now and what the plan is. Effective dates are mostly relevant in the Organization structure. It can be important for some metadata elements as well.

### Scenario

In accordance with an embodiment, the system also allows a user to define a scenario strategic component. The scenario strategic component is a description of several possible descriptions of a situation. Hypothetical situations are interspersed with expected extrapolations of trends to list a combination of events that describes how a situation might occur. Scenarios are used in what-if analysis, in which analysis assumptions can be changed.

### Key Performance Indicators (KPIs)

KPIs, or Key performance metrics, can be the indicators of how a business is performing relative to its strategic objectives. KPIs are quantifiable performance statements. The KPIs are relevant to the objective and strategy, and are placed in the context of a target to be reached in an identified time frame. Additionally, the KPIs are capable of being trended, and are owned by a designated person or group who has the ability to impact those measures. In accordance with an embodiment, the scorecard application uses metadata to manage the KPIs, based on the information provided by the business intelligence server. In accordance with an embodiment, KPI Value defines the calculation used to determine the value for the KPI (e.g. ((Sales−Cost)/Sales)*100%). The following sections include exemplary KPIs.

### Quantifiable Goal

In accordance with an embodiment, the system allows a user to define a target KPI. A target KPI can be a quantifiable goal for each measure. Targets create opportunity to succeed, help the organization monitor progress toward strategic goals, and communicate expectations. Quantifiable targets are specified for a timeframe. The level of performance or rate of improvement is required for a particular measure. Targets are stated in specific units ($, #, %, Rating, etc.), and should include time-based segments (annually, quarterly, etc.) as appropriate.

### Threshold or Range

In accordance with an embodiment, the system also allows a user to define a threshold or a range KPI. The threshold or a range KPI includes assessment rules to determine the KPI status at any given time. The thresholds define ranges of values that are used to compare with the KPI value. The KPI status contains the name of a range. In an embodiment, thresholds can be statements other than simple numbers. The statement can include expressions that enable the thresholds to vary over time and in response to external factors. In an embodiment, two thresholds are defined giving three ranges (e.g. “OK”, “Warning” and “Critical”). In another embodiment, a user can define any number of thresholds.

### Status

In accordance with an embodiment, the system also allows a user to define a status KPI. The status KPI is defined as the result of an assessment. Status can be OK, Critical or Warning or could be a Star in a Star rating system. Status can be associated with colors, which is not limited to Red, Yellow, and Green.

### Trend

In accordance with an embodiment, the system also allows a user to define a trend KPI. The trend KPI shows whether the KPI value is rising, falling or remaining unchanged compared to the last period. The scorecard application can also show whether this is a good or bad thing, using red/green color coding, based on whether the rise/fall is heading towards or away from the target value.

### Change

In accordance with an embodiment, the system also allows a user to define a change KPI. The change KPI shows how much the KPI value has changed between the previous and current periods. A KPI Variance describes how far the KPI value is from its target. The variance is usually shown in either percentage or real terms.

### Balanced Scoreboard

In accordance with an embodiment, the scorecard application can be a balanced scorecard that is balanced across a wide set of perspectives. The balanced scorecard can conform to the standards established by the Balance Scorecard collaborative, and includes minimally the perspectives in Financial, Customer, Internal Process and learning and growth, as defined by the collaborative.

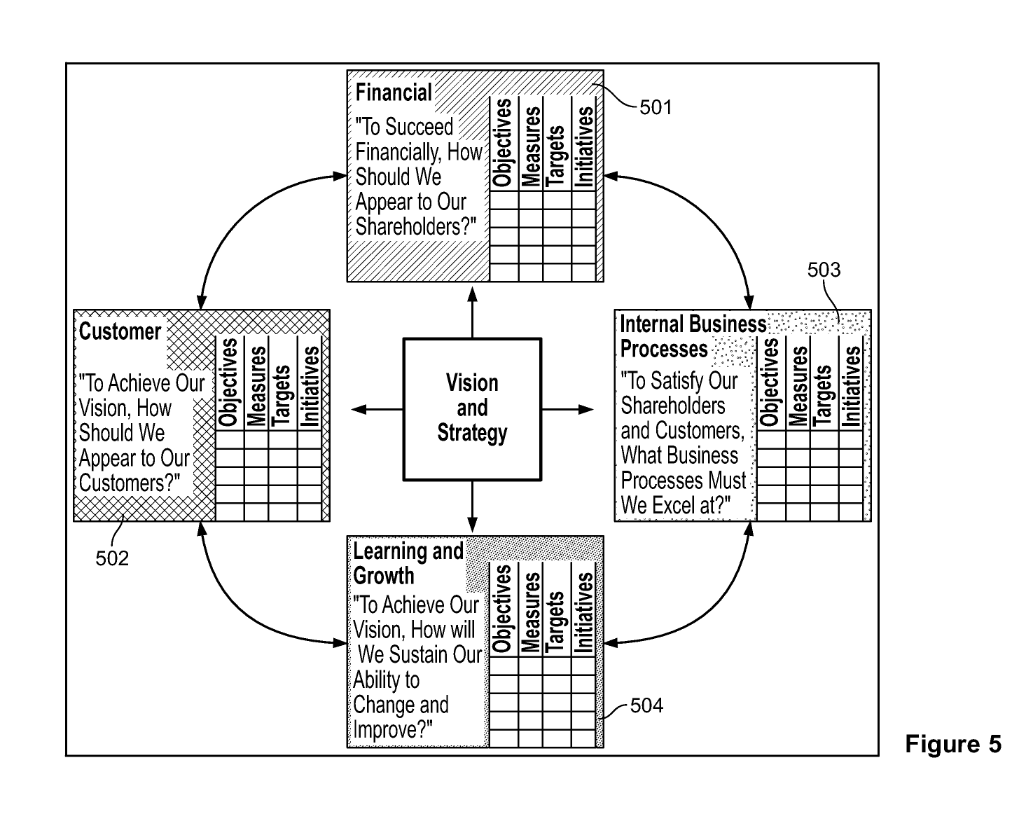

FIG. 5 illustrates an exemplary view of the balanced scorecard (BSC) methodology in accordance with an embodiment. As shown in FIG. 5, the BSC methodology enables businesses to define and articulate strategies that are balanced across different perspectives. The balanced scorecard provides business the language to define strategies that cater multiple, relevant perspectives. The balanced scorecard covers the financial 501, customer 502 (such as retention and lifetime value improvements), internal processes 503 (such as enhance operational efficiency), and learning and growth 504 (such as build and nurture the core business IP). In accordance with an embodiment, users can take advantage of the tools and language of the scorecard methodology without being constrained by the parameters of the methodology.

In accordance with an embodiment, within a balanced scorecard, users are allowed to drill, or navigate, from any part of the strategy definition to check the constituent information. In an embodiment, a user can drill from a high-level objective to its constituents. In another embodiment, a user can drill from an objective to the underlying metrics to monitor the progress associated with the Objective.

The balanced scorecard further provides drill-down and slice-and-dice capabilities to navigate from scorecards to analysis reports. Users are provided with means to publish strategies to other users. A user can also customize the strategy views, while sharing the strategy definition and content of the definition. The balanced scorecard further allows users to include strategy related visualizations within dashboards. Users can print out strategy components in a desirable manner.

The balanced scorecard further allows users to collaborate via annotations, such as annotations on metadata and annotations on data cells. Workflow can be supported in the balanced scorecard. A user is allowed to initiate workflows from within the context of building a scorecard, or monitoring progress on a scorecard. Users can also build a summary for a scorecard, such as a briefing book. In accordance with an embodiment, customizations and interactions, supported in the balanced scorecard environments, can have well-defined semantics for strategy components.

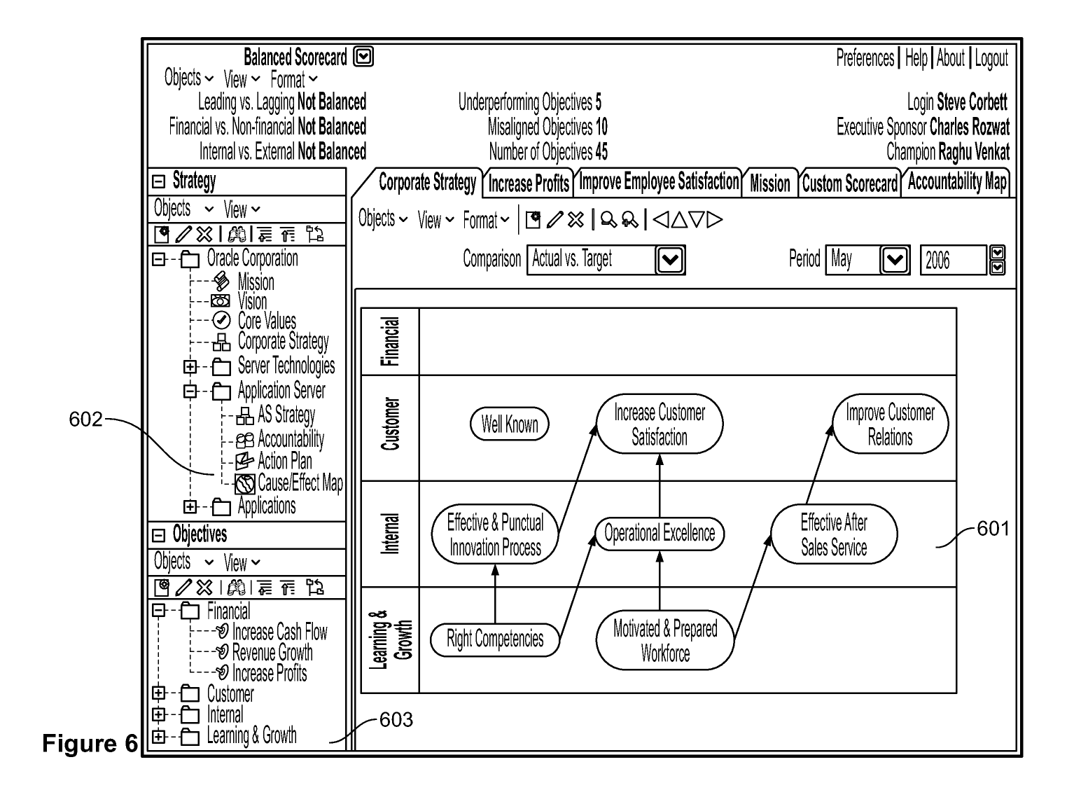

FIG. 6 illustrates an exemplary user interface (UI) for a balanced scorecard in accordance with an embodiment. As shown in FIG. 6, the exemplary user interface includes a panel 601 that shows a corporate strategy and other important information. Additionally, there can be two separate panels 602 and 603, which include tree views of the strategy and objectives respectively in order to manage the balanced scorecard environment.

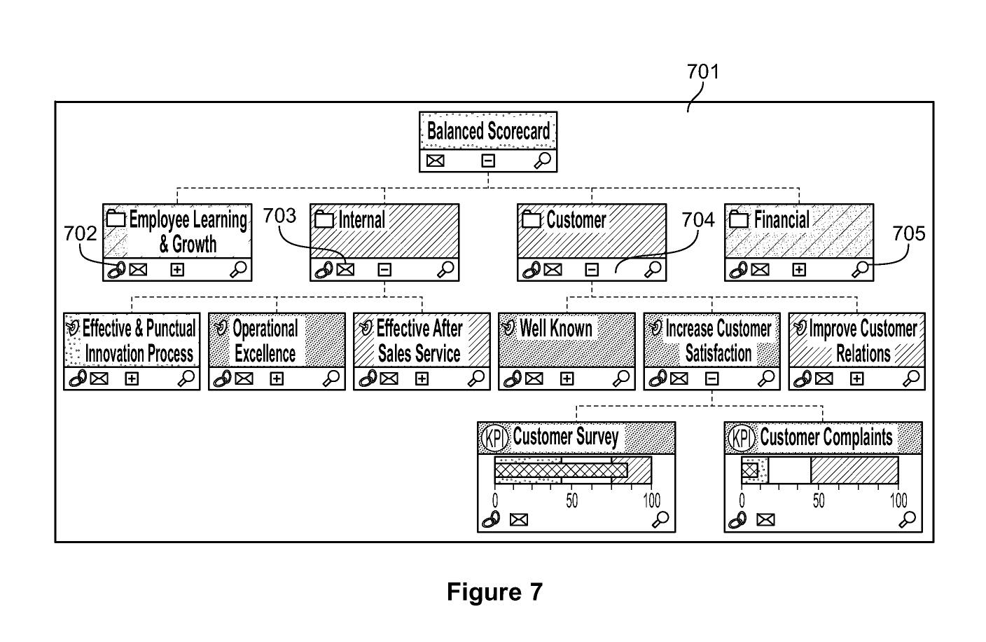

FIG. 7 illustrates an exemplary strategy tree in a balanced scorecard in accordance with an embodiment. As shown in FIG. 7, the exemplary strategy tree 701 includes different strategy components such as an “Employment Learning & Growth” element 702, an “Internal” element 703, a “Customer” element 704, and a “Financial” element 705, accordingly to the BSC methodology. Among them, the “Internal” element and the “Customer” element have different sub-elements that detail the two elements respectively. Furthermore, a strategy component in the strategy tree can contain common attributes that can be shared by different types of strategy components.

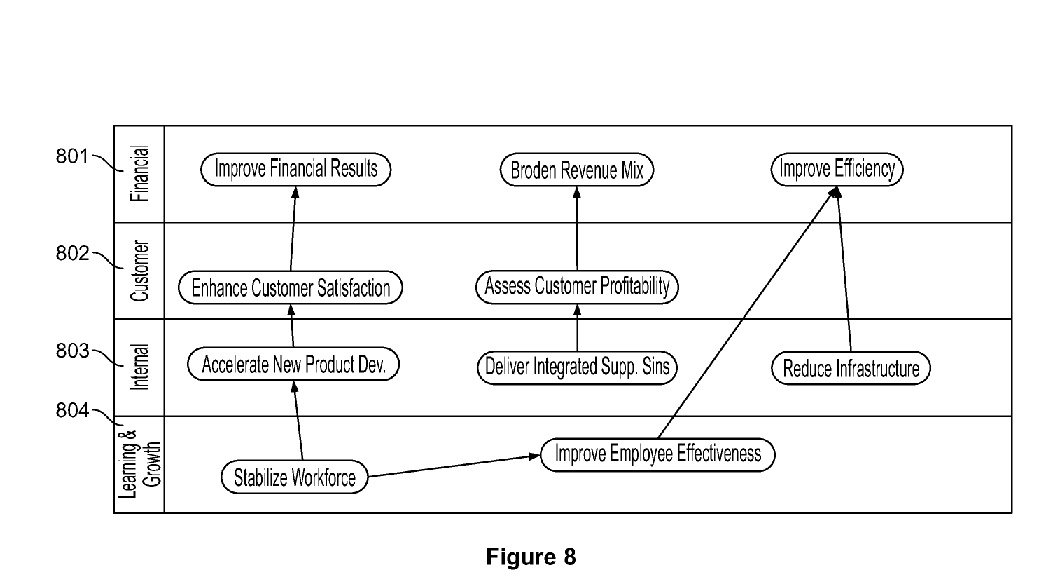

FIG. 8 illustrates an exemplary user interface (UI) for presenting a strategy map in accordance with an embodiment. A strategy map is visual representation of the strategy tree. The strategy map is complementary, or supplementary, to the strategy tree view. The linkages can be easily changed and edited as appropriate.

In accordance with an embodiment, the strategy map can also be used as a guidance to build a scorecard application that conforms to the BSC methodology. A balanced scorecard Strategy map includes the perspectives and themes used to segment the objectives. As shown in FIG. 8, the strategy map can include four rows 801, 802, 803, and 804, each of which contains strategy components that are corresponding to a different category in the BSC methodology.

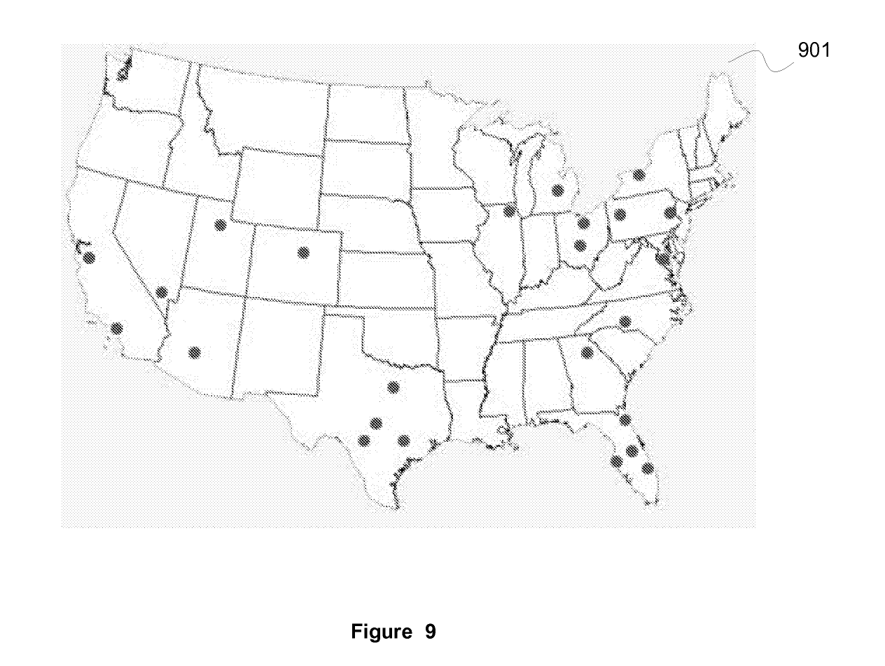

FIG. 9 is an illustration that shows an example of a user-customized strategy map in accordance with an embodiment. In accordance with an embodiment, the scorecard application allows users to build a tree or a forest, which is a disconnected set of trees, on either a blank page or on top of an image of choice. As shown in FIG. 9, multiple strategy trees can be scattered on top of a U.S. map 901, based on the geographical information associated with each individual strategy tree.

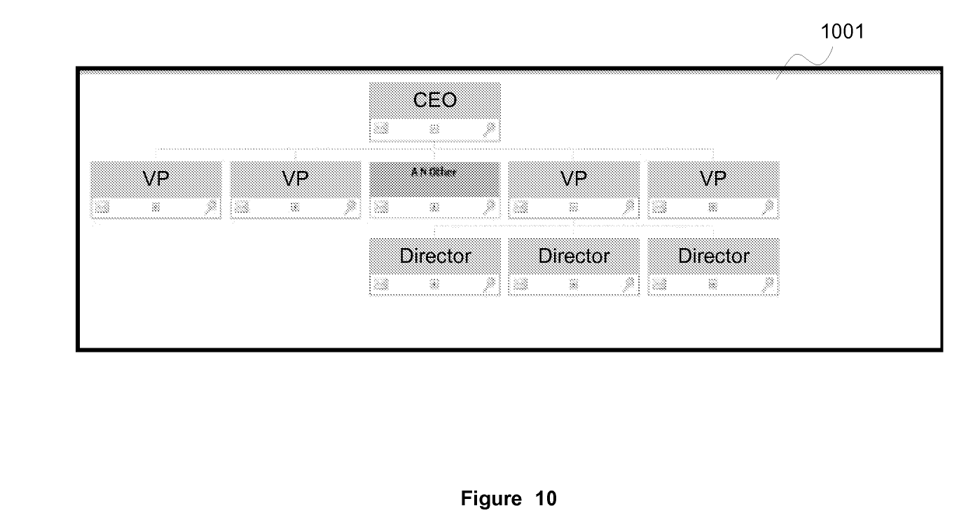

FIG. 10 illustrates an exemplary user interface (UI) for presenting an accountability map in accordance with an embodiment. As shown in FIG. 10, the accountability map can overlay the objectives and detailed KPIs on an organization tree 1001 with respect to owners. Users of the scorecard can customize on elements they want to see, such as objectives, KPIs. The tree can be drawn with different objectives of the owners. The Assessment rules can be used to create different coloring of the individual nodes of the accountability map.

The following sections include exemplary use cases that are associated with a balanced scoreboard application.

### Create Strategic Direction

An exemplary use case allows an actor to create strategic direction using the balanced scoreboard application. The actors can be senior management personnel, such as CEO, CFO, or CIO.

In an embodiment, creating strategic direction involves creating (1) a Corporate Vision, and (2) a Corporate Mission. Using the balanced scoreboard application, the board of directors and senior officials, such as CEO, CFO and CIO, can formulate a long-term vision and mission statements.

The balanced scoreboard application allows the actor, or some person on behalf of the actor, to log in the balanced scorecard application first. Then, the actor can use the strategy designer to create a strategy object with the type of vision. Then, the actor assigns a name for the vision and enters a description for the vision.

The user can attach a document containing the details of the vision. This can be public information and the document can be accessed by all employees of the company through a URL from the intranet. When user saves the Vision object, the system saves the Vision in the metadata repository. The user can create a Mission statement in a similar manner. Additionally, a user can organize the corporate strategy object hierarchy.

### Create Overall Strategy

Another exemplary use case allows an actor to create overall strategy using the balanced scoreboard application. Creating overall strategy involves creating (1) Objectives and (2) Strategic Themes. The actor can be each of the senior management personal, which is responsible for articulating corporate level objectives. For example, a CFO can articulate financial objectives and a CIO can articulate operational objectives.

The balanced scoreboard application allows the actor to log in the balanced scorecard application first. Then, the actor uses the strategy designer creates a strategy object definition called objective. The actor assigns a name and description to an objective. The actor can assign a perspective to classify the objective.

Additionally, the actor can create a strategy object definition called theme. The actor can assign the objective to a strategic theme. In the cases that objectives contain sub-objectives, the actor creates sub objectives.

In order to measure the performance of the objectives, the actor can choose an assessment rule, such as “Best Case,” “Worst Case,” and “Most Frequent.” User can create specific owners for individual objectives.

### Create Initiatives for Achieving Objectives

Another exemplary use case allows an actor to create initiatives for achieving objectives using the balanced scoreboard application. The actor can be each of the senior management personal, which is responsible for articulating higher-level initiatives within the company to achieve the objectives.

The balanced scoreboard application allows the actor to log in the balanced scorecard application. Then, the actor uses the strategy designer to create a strategy object called the strategic initiative. The actor assigns a name and description for the initiative. User can create specific owners for the initiative. If the company has a project system, the actor can create one or more project definitions and links to the strategic initiative. If there is no existing project system, the user can create start date and end date for the project.

### Create Communication Strategy

Another exemplary use case allows an actor to create communication strategy using the balanced scoreboard application. The actors can be senior Management (CEO, CFO, CIO) or middle-level management (VP Finance, VP Human Resource etc). In an embodiment, each of the senior management personal can assign specific owners to the objectives and initiatives and share the objectives and initiatives with the assigned owners.

The balanced scoreboard application allows the actor to log in the balanced scorecard application. For each of the objective and initiative, the actor creates an action plan, which includes tasks to complete the definition of the individual objectives and initiatives. Through the workflow, these tasks are communicated to the middle-level management personal. For example, an email can be sent to the interested parties. When the middle-level management personal signs on to the application, they have specific notes to come up with the metrics to measure each of these objectives.

### Create Metrics or KPI Definitions

Another exemplary use case allows an actor to create metrics or KPI definitions using the balanced scoreboard application. The actors can be senior management (CEO, CFO, CIO) and middle-level management (VP Finance, VP HR etc). Each of the middle-level management defines the KPIs for each of the objectives.

The balanced scoreboard application allows the actor to log in the balanced scorecard application. For each of the objective, when there is a task to create metrics, the actor can createsmultiple KPI definition using the strategy designer. The actor assigns to the KPI a description and supporting documentation. The actor defines how the metric is calculated. In some embodiments, when the data is not captured, the actor can work with information technology (IT) personnel to capture data for the metric. The actor defines the rules for the targets. The user can also assign higher-level targets for each metric.

The users can communicate the target information higher up in the chain to get approvals. Also, through the workflow, these tasks can be communicated to the mid level management personal. The actor then defines assessment rules for the KPI, such as defining colors and thresholds. In some embodiments, users can assign weights to the individual KPIs that are associated with the objective.

### Create Strategy Maps to Define Causes and Effects

Another exemplary use case allows an actor to create strategy maps to define causes and effects using the balanced scoreboard application. The Actors can be senior management (CEO, CFO, CIO) and middle-level management (VP Finance, VP Human Resource etc). After the objectives and individual measures are defined, the senior management and the middle-level management, can define correlations between objectives in the system.

The actor uses the strategy designer to create a strategy map, after logging in the balanced scoreboard application. The actor can see the hierarchy of objects—Vision, Mission, Objectives and KPIs for each objective. The actor uses these objects and places individual object inside the strategy map. The actor can then define causes and effects links between objectives. The actor can ask the system to predict the relationships. The strategy map can then be saved and be included inside a dashboard. The actor can share the created strategy map with any other user in the system.

### Cascade Strategy Definitions

Another exemplary use case allows an actor to cascade strategy definitions using the balanced scoreboard application. The actors can be CEO, and VPs, such as VP Customer Support.

Senior management personnel can articulate corporate level objectives, after logging in the balanced scoreboard application. For example, a CEO may define the corporate level objectives, themes and initiatives, using the strategy designer. The CEO can further define the owner for each object and shares the object with the person responsible. Then, a Vice President can log into the application. As part of achieving the corporate objectives, the Vice President can choose to follow a hybrid model. The Vice President can specify some objectives, which are identical to the corporate objectives. In addition, the Vice President can define some objectives at the department level which allows to achieve overall corporate objectives. These objectives can be linked to the corporate objectives. The Vice President can further define some objectives/KPIs, which are specific to the individual department, that are not linked to the corporate objective. The measurement of these KPIs is to ensure smooth running of the tasks the department is assigned. The Vice President can then share or cascade the objectives for various departments he or she manages.

### Build or Customize a Dashboard

Another exemplary use case allows an actor to build or customize a dashboard with multiple views using the balanced scoreboard application. The actors can be scorecard user.

The balanced scoreboard application allows the users to monitor the performance, after the strategy objects are defined in the system. Depending on an individual role, each user can view certain portions of the strategy. As part of the application, the actor either creates a new dashboard or customizes exiting dashboard. The actor can choose to include any strategy map from the palette of available scorecards, strategy maps or other views. The actor can see the hierarchy of objects—Vision, Mission, Objectives and KPIs for each objective. The actor uses these objects and places individual object inside the strategy map. The actor can then define causes and effects links between objectives. The actor can ask the system to predict the relationships. The strategy map can then be saved, and can then be included inside a dashboard.

### Assessments to Trigger a Notification

Another exemplary use case allows assessments to trigger a notification using the balanced scoreboard application. The Actors can be any scorecard users. After the strategy objects are defined in the system, the users can monitor the performance.

The actor can create a new “Delivers” alert based on the assessment of an individual KPI or objective, after logging in the balanced scoreboard application. When the assessment is run, the system checks whether a alert condition is met. The user can choose a form of delivery of notification (Email, Text Message etc). Then, the system notifies the user, with the details of assessment like status, and other details chosen by the user.

### Perform an Action Based on Registered Notification

Another exemplary use case allows an actor to perform an action based on registered notification using the balanced scoreboard application. When an alert notification is delivered to a user, they can collaborate or take action based on the notification. If the delivery mechanism is Email, the user can click on the link to access details.

The user is directed to the objective or KPI that is under-performing, after logging in the balanced scoreboard application. The user can then use a tool, such as Answers, to explore the KPI to see the details, and find out why the KPI is under-performing. The actor can enter comments on the KPI, seeking explanation of why a particular department is under performing. The actor can then trigger and Email notification to the department owner for providing further input. Based on the email, the department owner can trigger a process to take corrective actions.

### Override an Assessment

Another exemplary use case allows an actor to override an assessment using the balanced scoreboard application. When an alert notification is delivered to a user, the user can override the assessment value.

The user is directed to the objective or KPI that is under performing, after logging in the balanced scoreboard application. The user can use a tool, such as Answers, to explore the KPI to see the details, and find out why the KPI is under-performing. The actor can perform either of the two operations. The actor can reset the targets for the KPIs, so that the KPIs are adjusted based on certain assumptions. The actor then enters annotations describing why the overriding of the target was made. The actor can alternatively override the assessment status for a particular KPI and save the assessment status in the system. The system can trigger assessments of objectives up in the chain because of the changes to the assessments in the underlying KPIs.

### Create a Presentation

Another exemplary use case allows an actor to create a presentation, such as a briefing book, to present the strategy of the company or showcasing the performance of the company. The Actors can be middle level management personal. The briefing book can be a slideshow or a presentation.

The User can navigate to the briefing book designer to create a new briefing book after logging in the balanced scoreboard application. The actor can navigate to different dashboards and chooses different components such as a strategy map, KPI watch list or a set of gauges or charts. The different dashboards can be included in the briefing book in certain order. Also, the User can change the placements of the different dashboards in the briefing book. Additionally, the User can save and print the briefing book.

The present invention may be conveniently implemented using a conventional general purpose or a specialized digital computer or microprocessor programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. Many modifications and variations will be apparent to the practitioner skilled in the art. The code examples given are presented for purposes of illustration. It will be evident that the techniques described herein may be applied using other code languages, and with different code.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system to support business strategy management, comprising:
a computer with one or more processors;
a business intelligence (BI) server running on the computer, wherein the BI server operates to take inputs from different data sources; and
a scorecard application associated with the BI server, and wherein the BI server operates to
define an internal data structure that holds a plurality of strategy components and one or more key performance indicators (KPIs),
populate each said strategy component in the internal data structure based on the inputs from the different data sources, and
perform one or more actions once an alert is triggered, wherein the alert is triggered when a said KPI meets one or more criteria.

2. The system according to claim 1, wherein:
the scorecard application is a balanced scorecard application.

3. The system according to claim 1, wherein:
each said KPI can be evaluated using one or more assessment rules.

4. The system according to claim 1, wherein:
the plurality of strategy components can be associated with one or more metrics that are quantifiable performance statements.

5. The system according to claim 1, wherein:
the internal data structure is a strategy tree that includes hierarchically defined components.

6. The system according to claim 5, wherein:
the strategy tree can be represented using a strategy map.

7. The system according to claim 5, further comprising:
a causes and effects relationship map that includes one or more causes and effects linkages among one or more nodes in the strategy tree.

8. The system according to claim 5, further comprising:
an accountability map that overlays one or more said strategy components and one or more key performance indicators on an organization tree with respect to owners.

9. The system according to claim 5, wherein:
the strategy tree can be cascaded into another strategy tree that is associated with a different user.

10. The system according to claim 5, wherein:
the scorecard creates and manages the strategy tree based on one or more metadata.

11. The system according to claim 1, further comprising:
an action framework that can generate the one or more actions.

12. The system according to claim 1, wherein:
the one or more actions are generated based on a role that is associated with a user of the scorecard application.

13. The system according to claim 1, wherein:
the one or more actions initiates one or more business processes.

14. A method for supporting business strategy management, comprising:
associating a scorecard application with a business intelligence (BI) server that operates to take from different data sources;
allowing the scorecard application associated with the BI server to
define an internal data structure that holds a plurality of strategy components,
populate each said strategy component in the internal data structure based on the inputs from the different data sources, and
perform one or more actions once an alert is triggered.

15. A machine readable medium having instructions stored thereon that when executed cause a system to:
associate a scorecard application with a business intelligence (BI) server that operates to take from different data sources;
allow the scorecard application associated with the BI server to
define an internal data structure that holds a plurality of strategy components,
populate each said strategy component in the internal data structure based on the inputs from the different data sources, and
perform one or more actions once an alert is triggered.
